(19) United States
(12) Patent Application Publication
(10) Pub. No.: US 2014/0069926 A1
(43) Pub. Date: Mar. 13, 2014

(54) LATCH SYSTEM WITH INERTIAL LOCK MECHANISM

(71) Applicant: NORTHLAND PRODUCTS, INC., Prescott, AZ (US)

(72) Inventors: William J. Michael, Chino, AZ (US); Reed A. Davis, Prescott, AZ (US); Patrick A. Hodan, Dewey, AZ (US)

(73) Assignee: NORTHLAND PRODUCTS, INC., Prescott, AZ (US)

(21) Appl. No.: 13/784,539

(22) Filed: Mar. 4, 2013

Related U.S. Application Data
(63) Continuation-in-part of application No. 13/613,356, filed on Sep. 13, 2012.

(51) Int. Cl. E05C 19/02; E05C 19/12

(52) U.S. Cl. CPC E05C 19/02; E05C 19/12
USPC 220/326; 292/95; 292/134

(57) ABSTRACT

A latch system includes a catch member and a sear element engaged with the catch member when the catch member is in a latch position. A swing lever is in geared engagement with the sear element. When the latch system is subjected to an acceleration event, the swing lever pivots in one direction so that the sear element pivots in the opposite direction to move the sear element out of engagement with the catch member. The latch system may further include a security mechanism that is configured to prevent the swing lever and sear element from moving in response to an acceleration event under the condition the latch system is not oriented in an upright and vertical orientation. When the latch system is returned to its upright position, the security mechanism may be configured to not interfere with the normal operation of the latch system.

### CROSS REFERENCE TO RELATED APPLICATION[S]

This application is a continuation-in-part of the earlier U.S. Utility patent application to Michael et al., entitled “LATCH SYSTEM WITH INERTIAL LOCK MECHANISM,” Ser. No. 13/613,356, filed Sep. 13, 2012, the disclosure of which is hereby incorporated entirely herein by reference.

### BACKGROUND

1. Technical Field

This disclosure relates generally to latch systems. More specifically, the present invention relates to a latch with inertial lock mechanism configured to selectively restrict access into a container.

2. State of the Art

Animals, such as bears, have a keen sense of smell and can easily detect food which has been discarded in containers left outdoors such as refuse bins and storage lockers. Once food has been discovered in such areas, the animals often return to these outdoor containers in the hope of finding additional food.

Animals in pursuit of a readily available source of food are problematic to human populated areas. For example, animals sometimes enter homes, garages, or even vehicles in search of food. Some animals, and bears in particular, can do significant property damage due to their size and strength. Furthermore, animals entering human inhabited areas can become injured or killed by moving vehicles, electrical lines, and other human accoutrements. Still further, these animals can lose their wariness towards humans, making them a potential threat to humans. Indeed, allowing bears to get into the garbage is one of the leading causes of bear-human encounters. Thus, to protect people, property, and the animals themselves, it is desirable to inhibit animals from accessing containers in which refuse and food are stored.

Various attempts have been made to prevent animals from getting into outdoor refuse containers and food storage lockers. For example, refuse containers are sometimes stored inside sturdy locked buildings, in roofed chain link enclosures, and so forth. Unfortunately, food refuse in an enclosure still gives off odors that attract bears and other wildlife.

Latches have been used on a multitude of enclosures for selectively allowing ingress to or egress from such enclosures. Increasingly, latches are being incorporated with refuse containers in an attempt to prevent animals from accessing food and food-containing refuse placed in these containers by humans. Indeed such refuse often attracts the attention of animals in areas adjacent to animal habitats.

A large variety of latches exist which include mating mechanical parts that engage to fasten two or more objects or surfaces together while allowing for the regular or eventual separation of the objects or surfaces. For example, a latch may be used to engage a lid to a container, a door to a cupboard, a gate to posts, and so forth. Many latches may additionally include locking mechanisms that are selectively locked to prevent ingress to or egress from the particular objects to which the latches are coupled.

Refuse containers may be outfitted with a latch system to prevent an animal from opening the container. These latch systems can be problematic, however, because they can be difficult for a user to manipulate. Furthermore, these latch systems typically require the user to unlatch and subsequently re-engage the latch after use. If the latch is not re-engaged the container is not protected from animal access. Additionally, some latch systems can still be opened by animals through luck, persistence, or cleverness.

Another approach is to build the container using heavy, reinforcing components designed to inhibit animals from physically damaging the container in order to gain access. These reinforcing components can make the container undesirably heavy and unwieldy to move. In addition, these heavy, reinforcing components can cause premature damage, such as failure of the container hinges after repeated use.

In an effort to control costs associated with refuse collection, many municipalities are implementing “fully-automated collection” techniques. Fully-automated collection involves the use of a truck with an automated, mechanical gripping arm to lift a specially-designed container from the curbside, dump the container contents into the truck, and return the container to the curbside. Such a system typically requires only one person to operate because the truck driver controls the gripping arm from the cab of the truck. In contrast, traditional collection systems require one or two laborers and a driver to collect refuse.

Fully-automated collection relies on the cooperation of the residents to place the refuse containers in the proper location and position for collection. Unless the resident places the refuse container in the proper location at the moment that the truck approaches, a container without a latch system is vulnerable to animals while the container awaits refuse collection. A container with a latch system is also problematic because when the container is placed in the proper location, it must be unlatched so that the contents of the container will be successfully emptied. Accordingly, a container with a disengaged latch system is also vulnerable to animals while the container awaits refuse collection. Alternatively, the refuse vehicle operator may exit the truck to disengage the latch system. However, such a procedure is undesirably inconvenient and time consuming. A container using heavy, reinforcing components may be difficult for a resident to place in the proper location and may not conform with the size, shape, and weight requirements needed to safely function with the automated, mechanical arm.

Accordingly, what is needed is an animal-resistant container incorporating a latch system that is easy to use, relatively lightweight for residential use, mechanically robust, and is compatible with both manual and fully-automated collection systems.

### SUMMARY

The present disclosure relates to a latch with inertial lock mechanism configured to selectively restrict access into a container.

An aspect of the present disclosure includes a latch system comprising a locking mechanism configured to transition between a locked position and an unlocked position, and a securing mechanism configured to allow the locking mechanism to transition from the locked position to the unlocked position under the condition the latch system is oriented in a first orientation and to prevent the locking mechanism from transitioning from the locked position to the unlocked position under the condition the latch system is oriented in a second orientation different than the first orientation.

Another aspect of the present invention includes the locking mechanism further comprising a sear element, and a swing lever in functional engagement with the sear element, the swing lever being configured to move in response to an acceleration event, such movement resulting in the locking mechanism transitioning from the locked position to the unlocked position.

Another aspect of the present invention includes a catch member in functional communication with the sear element and configured to transition between a latched position and a release position, wherein under the condition the locking mechanism is in the locked position the catch member is maintained by the sear element in the latched position, and wherein under the condition the locking mechanism is in the unlocked position the catch member is free to transition between the latched position and the release position.

Another aspect of the present invention includes a closure element to a container, the closure element being in functional communication with the catch member and being configured to transition between a closed position and an open position relative to the container, wherein under the condition the catch member is in the latched position the closure element is maintained in the closed position, and wherein under the condition the catch member is in the release position the closure element is free to transition between the closed position and the open position.

Another aspect of the present invention includes a housing in which at least portions of the catch member, the sear element, and the swing lever are located, and a spring having a first end coupled to the swing lever and having a second end coupled to the housing, wherein the swing lever is biased toward a locked position by the spring to urge the sear element in substantially continuous engagement with the catch member in the absence of the acceleration event.

Another aspect of the present invention includes wherein the catch member comprises an engagement area and the sear element comprises a latch area configured for contact with the engagement area to retain the catch member in the latched position, the latch area moving out of contact with the engagement area in response to the acceleration event.

Another aspect of the present invention includes wherein the second orientation is oblique to the first orientation and/or wherein the second orientation is substantially orthogonal to the first orientation.

Another aspect of the present invention includes a holder assembly functionally coupled to the locking mechanism, and a blocking member, wherein under the condition the latch system is oriented in the first orientation the holder assembly is configured to permit the locking mechanism to transition from the locked position to the unlocked position without engaging the blocking member.

Another aspect of the present invention includes wherein the holder assembly is functionally coupled to a swing lever of the locking mechanism, the swing lever being configured to pivot between the locked position and the unlocked position about a first pivot axis and the holder assembly being configured to rotate with respect to the swing lever about a rotational axis substantially orthogonal to the first pivot axis.

Another aspect of the present invention includes wherein under the condition the latch system is oriented in the second orientation the holder assembly is configured to functionally engage the blocking member to prevent the locking mechanism from transitioning from the locked position to the unlocked position.

Another aspect of the present invention includes a cavity defined by the holder assembly, and a weight functionally coupled within the cavity, wherein under the condition the latch system is in the first orientation the weight is configured to provide resistance to an acceleration event to cause the locking mechanism to transition between the locked position and the unlocked position, and wherein under the condition the latch system is in the second orientation the weight is configured to cause the holder assembly to rotate about the rotational axis to engage the blocking member to prevent the locking mechanism from transitioning from the locked position to the unlocked position.

Another aspect of the present invention includes wherein the cavity further comprise a ridge thereon and the weight further comprises a groove therein, wherein the ridge is configured to functionally engage the groove under the condition the weight is coupled within the cavity.

Another aspect of the present invention includes an engagement member and a contact surface on the locking mechanism, wherein under the condition the latch system is oriented in the first orientation the engagement member is configured to permit the locking mechanism to transition from the locked position to the unlocked position without engaging the contact surface.

Another aspect of the present invention includes wherein the engagement member comprises a first end and a second end, the first end being configured to pivotally couple to a pivot rod and the second end being configured to engage the contact surface.

Another aspect of the present invention includes wherein under the condition the latch system is oriented in the second orientation the engagement member is configured to pivot about the pivot rod to bring the second end into functional engagement with the contact surface to prevent the locking mechanism from transitioning from the locked position to the unlocked position.

Another aspect of the present invention includes wherein the contact surface further comprises a raised edge that is configured to functionally engage second end and maintain functional engagement therewith under the condition the latch system is in the second orientation.

Another aspect of the present invention includes a restrictive member functionally coupled to the locking mechanism, wherein under the condition the locking mechanism is in the locked position the restrictive member is configured to permit the engagement member to pivot about the pivot rod to bring the second end into functional engagement with the contact surface, and wherein under the condition the locking mechanism is in the unlocked position the restrictive member is configured to prevent the engagement member from pivoting about the pivot rod to bring the second end into functional engagement with the contact surface.

Another aspect of the present invention includes a container having an interior volume and an opening, a closure element covering the opening, the closure element being movable relative to the container, a latch receptacle secured to the closure element, a latch system secured to the container and configured to functionally engage the latch receptacle to lock the closure element to the container.

Another aspect of the present invention includes the latch system further comprising a catch member, the catch member including a catch pivot and a hook, the catch pivot enabling pivotable movement of the catch member between a latch position and a release position, and the hook engaging with the latch receptacle in the latch position and pivoting out of engagement with the latch receptacle in the release position, a sear element engaged with the catch member under the condition the catch member is in the latch position, a swing lever in geared engagement with the sear element, the swing lever pivoting in a first direction in response to an acceleration event to cause the sear element to pivot in a second direction opposing the first direction thereby disengaging from the catch member such that the catch member is able to pivot to the release position, a housing in which at least portions of the catch member, the sear element, and the swing lever are positioned, and a spring having a first end coupled to the swing lever and having a second end coupled to the housing, wherein the swing lever is biased toward a locked position by the spring to urge the sear element in substantially continuous engagement with the catch member in the absence of the acceleration event, and a securing mechanism configured to prevent the swing lever from pivoting under the condition the apparatus is in a first orientation to thereby maintain the catch member in the latch position and to allow the swing lever to pivot under the condition the apparatus is in a second orientation different than the first orientation to thereby permit the catch member to transition from the latch position to the release position.

Another aspect of the present invention includes a manual actuation lever having a first end extending out of the housing, a second end, and a pivot axis interposed between said first and second ends, wherein manipulation of the first end causes the manual actuation lever to pivot about the pivot axis to move the second end into abutment with the swing lever and urge the swing lever to pivot in the first direction thereby freeing the catch member to move to the release position.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

A more complete understanding of some embodiments of the present disclosure may be derived by referring to the detailed description and claims when considered in connection with the Figures, wherein like reference numbers refer to similar items throughout the Figures, and:

FIG. 1 shows a perspective view of a latch system in accordance with an embodiment;

FIG. 2 shows a perspective view of an apparatus that includes an enclosure system in which the latch system of FIG. 1 may be utilized;

FIG. 3 shows top perspective view of a container of the apparatus of FIG. 2;

FIG. 4 shows a partial sectional view of the container along section lines 4-4 of FIG. 3;

FIG. 5 shows a partial sectional view of a lid of the apparatus;

FIG. 6 shows a particular view of one of the latch receptacles along section lines 6-6 of FIG. 5;

FIG. 7 shows an exploded perspective view of a portion of the latch system;

FIG. 8 shows another exploded perspective view of a portion of the latch system;

FIG. 9 shows another exploded perspective view of a portion of the latch system;

FIG. 10 shows another exploded perspective view of a portion of the latch system;

FIG. 11 shows a partial side view of an inertial locking mechanism of the latch system in a locked position;

FIG. 12 shows a partial side view of the inertial locking mechanism of the latch system in the locked position, with a catch member being engaged with a latch receptacle in the apparatus of FIG. 2;

FIG. 13 shows a partial side view of the inertial locking mechanism of the latch system in an unlocked position with the catch member still being engaged with the latch receptacle;

FIG. 14 shows a partial side view of the inertial locking mechanism of the latch system in the unlocked position with the catch member being disengaged from the latch receptacle;

FIG. 15 shows a partial front view demonstrating the functional interaction between components when the catch member of the latch system is in a release position;

FIG. 16 shows a partial side view of the latch system being actuated utilizing a manual actuation lever;

FIG. 17 shows a partial perspective view of an actuation lock feature incorporated into the latch system;

FIG. 18 shows a partial perspective view of the actuation lock feature in a position that prevents actuation of manual actuation lever when the apparatus of FIG. 2 is moved away from an upright position;

FIG. 19 shows a side view of the inertial locking mechanism of the latch system in the locked position;

FIG. 20 shows a side perspective view of the inertial locking mechanism of the latch system in the locked position;

FIG. 21 shows an exploded view of a component of the inertial locking mechanism of the latch system and a component of an embodiment of a securing mechanism that is functionally coupled thereto;

FIG. 22 shows a side perspective view of the inertial locking mechanism of the latch system and a component of the embodiment of the securing mechanism attached thereto transitioning between the locked position and the unlocked position and passing by a blocking member;

FIG. 23 shows a side perspective view of the inertial locking mechanism of the latch system and a component of the embodiment of the securing mechanism attached thereto being blocked from transitioning from the locked position to the unlocked position because of the component of the securing mechanism being blocked by the blocking member;

FIG. 24 shows an exploded perspective view of the inertial locking mechanism of the latch system and an embodiment of the securing mechanism housed within the latch system;

FIG. 25 shows a partial front view of the inertial locking mechanism in the locked position and an embodiment of the securing mechanism;

FIG. 26 shows a partial front view of the inertial locking mechanism in the locked position and an embodiment of the securing mechanism in functional communication therewith;

FIG. 26A shows a perspective view of the inertial locking mechanism and an embodiment of the securing mechanism in functional communication therewith depicted in FIG. 26; and

FIG. 27 shows a partial front view of the inertial locking mechanism in the unlocked position and an embodiment of the securing mechanism in functional communication therewith.

FIG. 28 shows a partial side view of the inertial locking mechanism in the unlocked position and an embodiment of the securing mechanism in functional communication therewith depicted in FIG. 27.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

Embodiments entail a latch system for an enclosure, such as a container with a lid, and an apparatus that includes a container and closure element having the latch system incorporated therein. The latch system includes an inertial lock mechanism that automatically engages so that a user need not deliberately re-engage the latch after manually disengaging it. Additionally, the latch system automatically unlatches when the container is sharply lifted or briefly shaken.

In an example, the latch system is implemented with a container to produce an animal-resistant refuse container. Such a refuse container is useful for receiving and holding garbage, recyclable items, and the like. The refuse container with the latch system incorporated therein is configured to inhibit an animal, and especially large animals such as bears, peccaries, and the like, from accessing the contents of the container. When the container is tilted or tipped, the inertial lock mechanism will remain locked to prevent an animal intruder from access into the container. However, lift action imparted on the container by an automated, mechanical arm of a refuse truck is sufficient to unlock the inertial lock mechanism of the latch system so that the contents of the container can be emptied during automated collection. Although the latch system is directed towards inhibiting access of animals to a refuse container used for automated collection, embodiments of the latch system may be applied to inhibit access of animals in general to containers. Additionally, the latch system may be implemented to allow controlled access to a multitude of container designs, cupboards, gates, and the like.

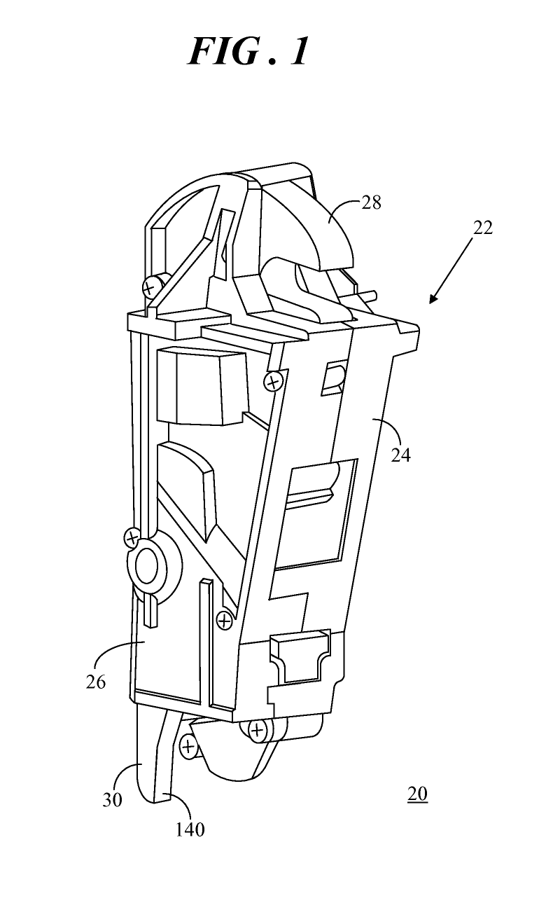

Referring now the Figures, FIG. 1 shows a perspective view of a latch system 20 in accordance with an embodiment. In an embodiment, latch system 20 is implemented within a refuse container (discussed below) to enable selective access of the container by humans and to largely prevent access of the contents of the container by animals. In general, latch system 20 includes a housing 22 having first housing element 24 and a second housing element 26 configured to be engaged with first housing element 24. Multiple components of latch system 20 reside within housing 22. However, at least a portion of a catch member 28 extends out of the top of housing 22 and at least a portion of a manual actuation lever 30 extends from the bottom of housing 22. The interconnection and function of the components of latch system 20, including catch member 28 and manual actuation lever 30, will be described in detail below.

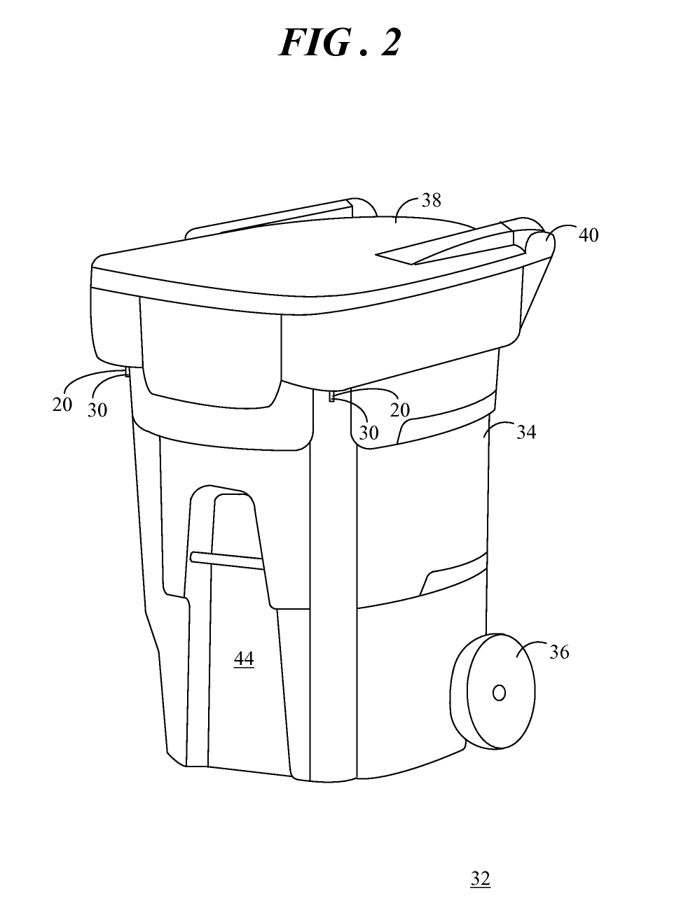

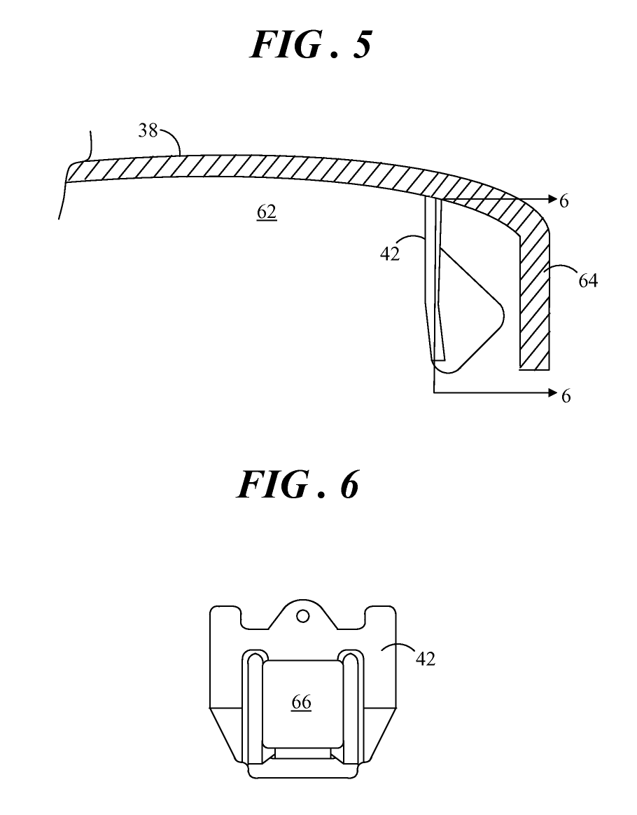

FIG. 2 shows a perspective view of an apparatus 32 that includes an enclosure system in which latch system 20 is incorporated. In general, the enclosure system includes a container 34 mounted on wheels 36 (of which one is visible), and a closure element, e.g., a lid 38 attached to container 34. Lid 38 may be pivotally attached to a handlebar 40 so that lid 38 can be opened to access an interior of body container 34. Apparatus 32 further includes at least one latch system 20 secured in container 34 and at least one latch receptacle 42 (visible in FIGS. 5 and 6) secured in lid 38.

In an embodiment, apparatus 32 includes two latch systems 20 and, correspondingly, two latch receptacles 42 (FIG. 5). However, as shown in FIG. 2, only manual actuation levers 30 of latch systems 20 are visible. Each of latch systems 20 and their corresponding latch receptacles 42 are spaced apart from one another and may be located at an exterior front surface 44 of container 34 of apparatus 32, for example, at opposing front corners of exterior front surface 44. Each latch system 20 functions cooperatively with its corresponding latch receptacle 42 so that lid 38 is secured to container 34 to inhibit intrusion into apparatus 32, as will be discussed in greater detail below. In addition, latch systems 20 can be reliably actuated by an upward lift action produced by an automated collection refuse pickup vehicle to automatically disengage them from latch receptacles 42, as will also be discussed in greater detail below.

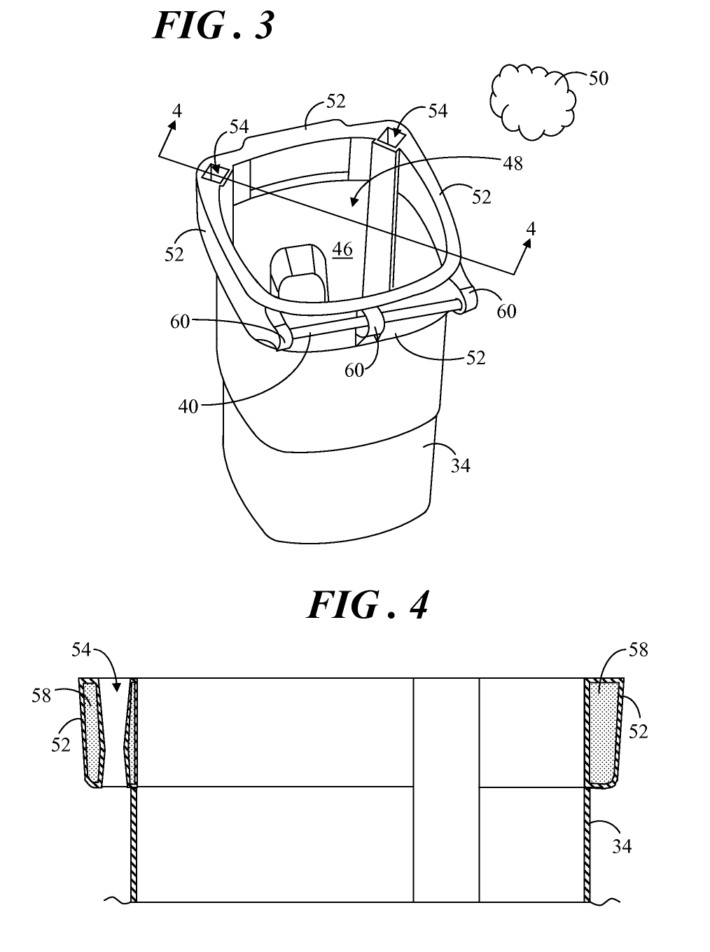

Referring to FIGS. 3-4 in connection with FIG. 2, FIG. 3 shows a top perspective view of container 34 of apparatus 32 and FIG. 4 shows a partial sectional view of container 34 along section lines 4-4 of FIG. 3. Container 34 is a walled structure having an interior volume 46 and an opening 48 for input of refuse 50 into interior volume 46. Container 34 may be formed from thermoplastic material, such as, polyethylene, polypropylene, acrylonitrile butadiene styrene (ABS), polyvinyl chloride (PVC), nylon, and the like. Container 34 may be manufactured utilizing a rotational molding process. A rotational molding technique and a thermoplastic material may be desirable for making container 34, due to cost effective production, as well as, high durability, corrosion resistance, and light weight of the finished product. In alternative embodiments, container 34 may be manufactured using another suitable molding process, such as injection molding, blow molding, and so forth.

Container 34 further includes a circumferential rim 52 encircling opening 48, and passages 54 are formed in circumferential rim 52 of container 34 during the rotational molding manufacturing process. At least a portion of latch system 20 may be housed in each passage 54. Passages 54 function to protect latch system 20 from an animal intruder and from inclement weather conditions. In an embodiment, an interior cavity 56 is formed in circumferential rim 52 and is filled with a foam material 58. Foam material 58 provides reinforcement at circumferential rim 52 in order to withstand damage from teeth and claws of an animal intruder. Container 34 may be further provided with reinforcing areas, relief areas, and so forth to provide the desired strength and stiffness to container 34. In addition, handle supports 60 and handlebar 40 can be integrally-formed with and at the same time as the formation of container 34. Handle supports 60 support the laterally extending cylindrical handlebar 40 to which lid 38 may be pivotally attached.

Referring to FIGS. 5-6 in connection with FIG. 2, FIG. 5 shows a partial sectional view of lid 38 of apparatus 32 and FIG. 6 shows a partial view of one of latch receptacles 42 along section lines 6-6 of FIG. 5. Like container 34 (FIG. 2), lid 38 may be formed from thermoplastic material using a rotational molding process.

Lid 38 may be slightly convex or dome-shaped. This convex shape produces a cavity 62 in the underside of lid 38 that is surrounded by a circumferential lip 64 of lid 38. Latch receptacles 42 are housed in cavity 62 and may be secured in lid 38 using any of a variety of bracket and/or fastener configurations (not shown). Alternatively, latch receptacles 42 may be integrally formed in lid 38 during fabrication of lid 38. When lid 38 is closed on container 34 (FIG. 2), latch receptacles 42 are protected from animal intruders, as well as inclement weather conditions. In an embodiment, each latch receptacle 42 includes a receiver, or latch strike, to which a catch member 28 (FIG. 1) of latch system 20 attaches. That is, a portion of catch member 28 extends into an opening 66 of latch receptacle 42. Latch receptacles 42 may take on various shapes (e.g., ring-shaped) and sizes to mate or otherwise attach with its associated catch member 28.

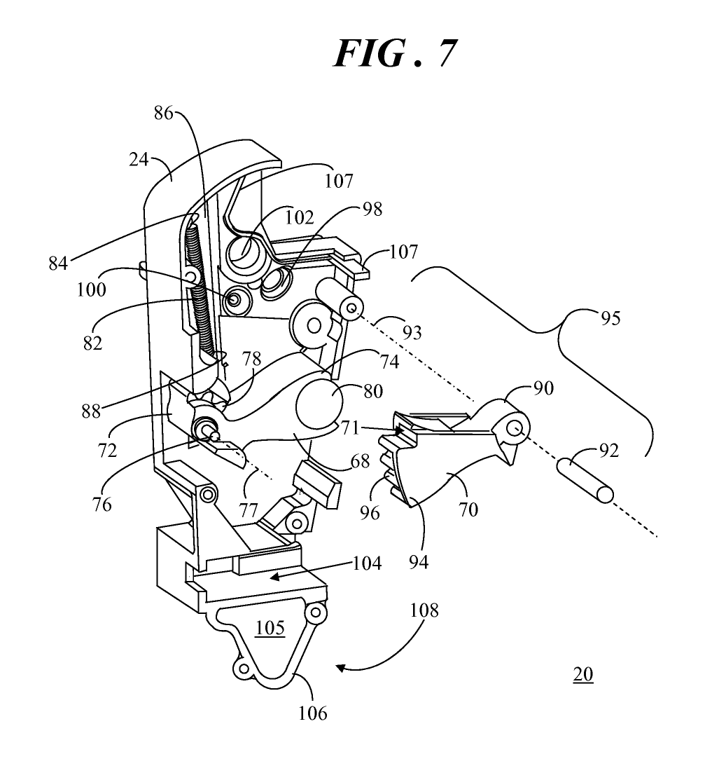

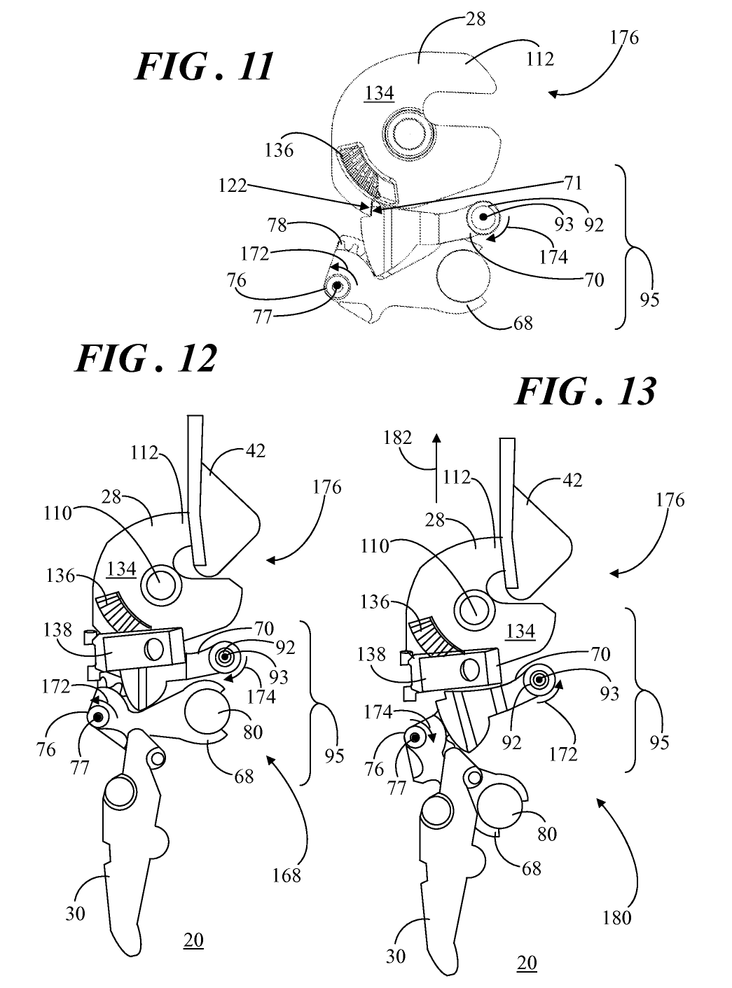

The following FIGS. 7-10 illustrate the various components of latch system 20 (FIG. 1) and demonstrate their assembly and interconnections to produce latch system 20. These various components will be described progressively in connection with FIGS. 7-10. The cooperative function of the various components after latch system 20 is assembled will be described in detail in connection with the subsequent FIGS. 11-17.

FIG. 7 shows an exploded perspective view of a portion of latch system 20. In this illustration, some components of latch system 20 and their interaction with first housing element 24 are visible. Latch system 20 includes a swing lever 68 and a sear element 70 configured for geared engagement with swing lever 68. Additionally, sear element 70 includes a latch area 71 that is configured for contact with an engagement area (discussed below) of catch member 28 (FIG. 1) to prevent catch member 28 from moving.

Swing lever 68 includes a first end 72 and a second end 74, where second end 74 opposes first end 72. First end 72 of swing lever 68 is coupled with first housing element 24 via a pivot shaft 76. Pivot shaft 76 defines a pivot axis 77, i.e., an axis of rotation, about which swing lever 68 is able to pivot. Swing lever 68 further includes gear teeth 78 located at first end 72 proximate pivot shaft 76. Second end 74 of swing lever 68 includes a weight 80 that provides resistance to an acceleration event (discussed below) that causes swing lever 68 to pivot about the pivot point at pivot shaft 76. Latch system 20 further includes a spring 82 having one end 84 coupled to an inner surface 86 of first housing element 24 and another end 88 coupled to swing lever 68.

One end 90 of sear element 70 is coupled with first housing element 24 via another pivot shaft 92. Thus, pivot shaft 92 defines a pivot axis 93 about which sear element 70 can pivot. The opposite end 94 of sear element 72 includes gear teeth 96. Gear teeth 96 of sear element 70 engage with gear teeth 78 of swing lever 68. Thus, when swing lever 68 pivots about pivot axis 77 in one direction, the geared engagement of sear element 70 with swing lever 68 will cause sear element 70 to pivot about pivot axis 93 in the opposite direction. In particular, when latch system 20 is subjected to an acceleration event (discussed below), weight 80 provides resistance to this acceleration event to cause swing lever 68 to pivot about pivot axis 77 and thereby cause sear element 70 to pivot about pivot axis 93. As such, swing lever 68 with weight 80 and sear element 70 are referred to herein as an inertial locking mechanism 95 of latch system 20 that prevents catch member 28 from pivoting under particular circumstances.

First housing element 24 can include additional features. In particular, at least two detents 98 and 100 are formed in inner surface 86 of first housing element 24. In addition, a pivot shaft receiver 102 is formed in inner surface 86. Detents 98 and 100 and pivot shaft receiver 102 function cooperatively with catch member 28 (FIG. 1), and will be discussed below. Additionally, first housing element 24 includes a receptacle 104 configured to hold a retainer element (discussed below) and a pocket 106 having a cavity 105. Pocket 106 forms part of an actuation lock 108 (again discussed below) for latch system 20. One or more sealing strips 107 may be included to largely prevent the entry of debris and/or water into housing 22 (FIG. 1) of latch system 20.

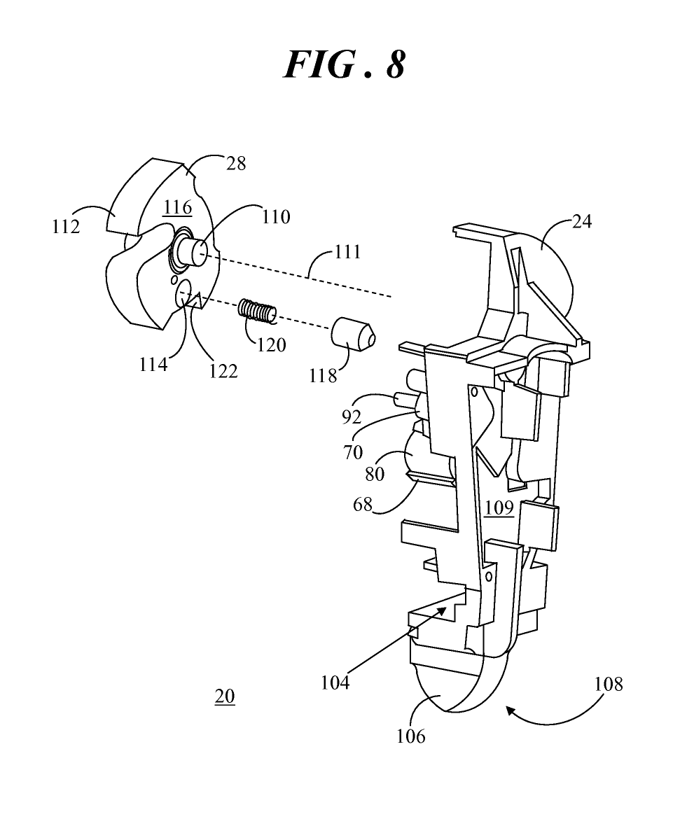

FIG. 8 shows another exploded perspective view of a portion of latch system 20. In this illustration, an outer surface 109 of first housing element 24 is visible. Additionally, some components of latch system 20 and their interconnection with first housing element 24 are visible. As shown, swing lever 68 and sear element 70 have been coupled to first housing element 24 via their respective pivot shafts 76 (FIG. 7) and 92. Additionally, a portion of receptacle 104 and pocket 106 of actuation lock 108 are visible.

Catch member 28 includes a catch pivot 110 configured to engage with pivot shaft receiver 102 (FIG. 7) formed in first housing element 24. Catch pivot 110 enables pivotable movement of catch member 28 about a pivot axis 111. Catch member 28 further includes a hook 112 configured to engage with latch receptacle 42 (FIG. 5). An indentation 114 is formed in a lateral surface 116 of catch member 28. A plunger 118 is installed in indentation 114 and a spring 120 is interposed between plunger 118 and indentation 114 so that plunger 118 is outwardly spring biased. Once installed, plunger 118 can interconnect with detents 98 and/or 100 (FIG. 7) as catch member 28 pivots to more reliably control the locking, unlocking, and pivoting movement of catch member 28.

The perspective view of catch member 28 further reveals an engagement area 122 formed as a notch at a lower region of catch member 28. Engagement area 122 of catch member 28 and latch area 71 (FIG. 7) of sear element 70 contact one another to retain catch member 28 in a latched, i.e., locked position.

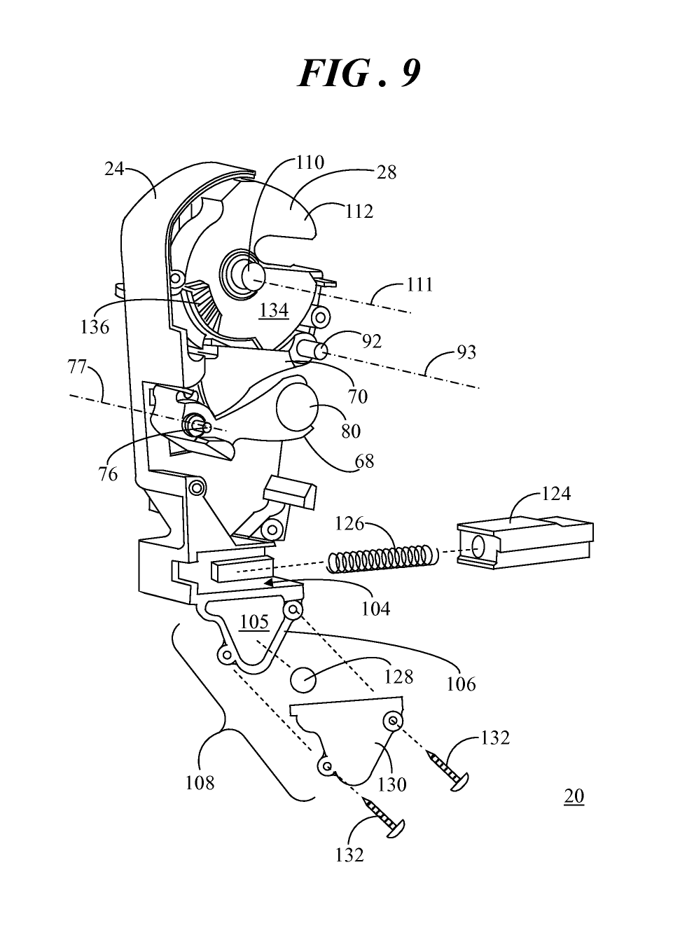

Now referring to FIG. 9, FIG. 9 shows another exploded perspective view of a portion of latch system 20. In particular, catch member 28 along with swing lever 68 and sear element 70 have now been coupled to first housing element 24. In addition, a retainer element 124 outwardly biased by a spring 126 is installed in receptacle 104 formed in first housing element 24. In an embodiment, housing 22 (FIG. 1) is sized and shaped to fit into one of passages 54 (FIG. 4) formed in container 34 (FIG. 2). Retainer element 124 is outwardly spring biased to retain, i.e., lock, latch system 20 in passage 54. In alternative configurations, latch system 20 need not include retainer element 124 and spring 126, but may instead have another structure for fastening latch system 20 into or on a container, cupboard, gate, or any other suitable enclosure.

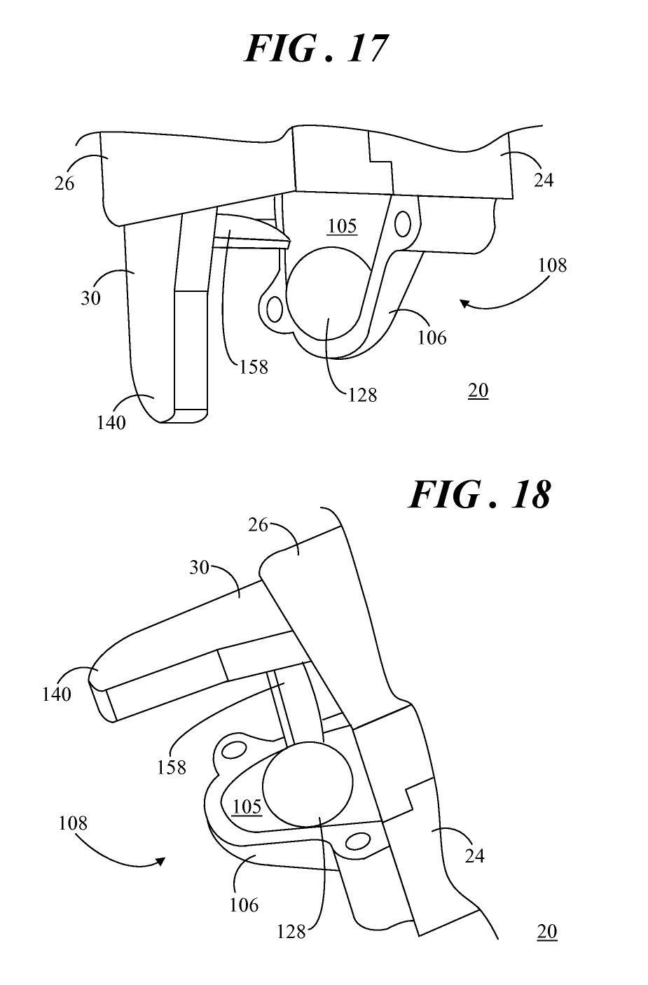

The exploded perspective view of FIG. 9 additionally reveals a ball 128 for installation into cavity 105 in pocket 106 of actuation lock 108. A pocket cover 130 is coupled to pocket 106 via threaded fasteners 132. In general, actuation lock 108 that includes pocket 106, ball 128, and pocket cover 130 functions to disable a manual unlatching feature of latch system 20 when apparatus 32 (FIG. 2) is tilted or tipped away from an upright position. Such an event can occur when an animal, such as a bear, tips apparatus 32 when trying to access the contents of container 34 (FIG. 2). The function of actuation lock 108 will be demonstrated in connection with FIGS. 17 and 18.

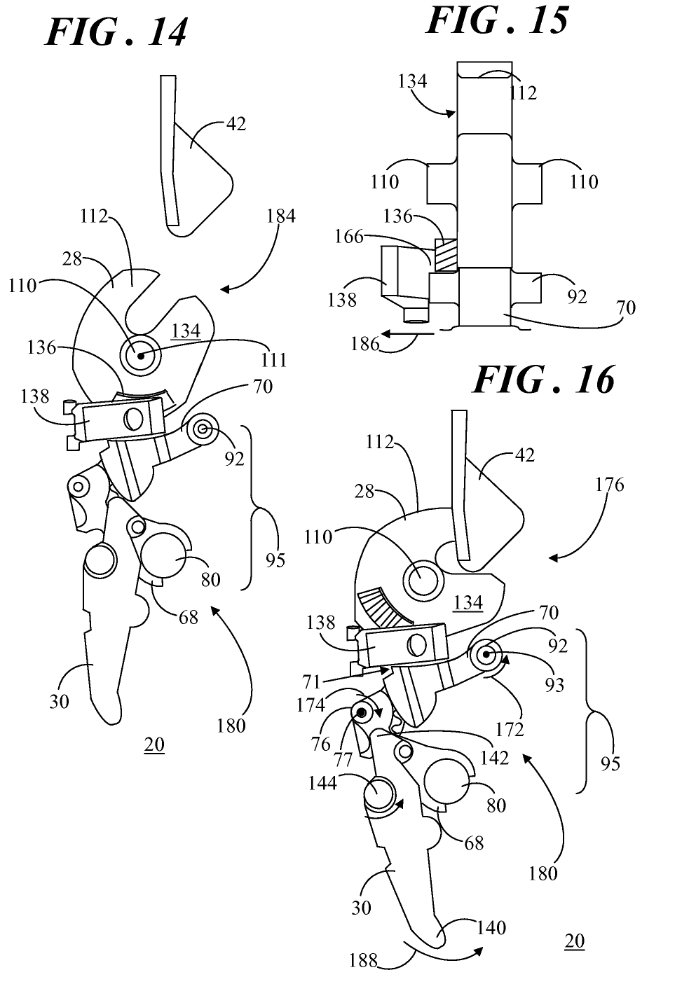

Now referring to catch member 28, shown in FIG. 9, a lateral surface 134 of catch member 28 has a cam 136 formed thereon. Cam 136 extends outwardly from lateral surface 134. Cam 136 transforms a rotational, or pivoting, motion of catch member 28 into a translational motion of a sear retainer (not shown) of latch system 20. This function will be demonstrated in connection with FIGS. 14 and 15.

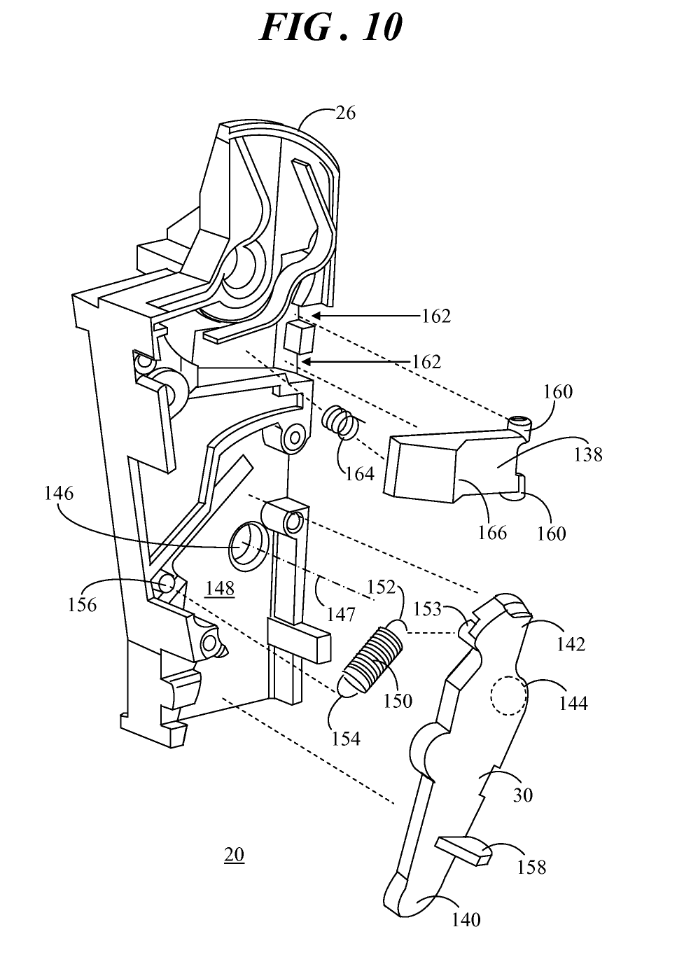

FIG. 10 shows another exploded perspective view of a portion of latch system 20. In this illustration, some components of latch system 20 and their interaction with second housing element 26 are visible. In particular, the design of manual actuation lever is revealed. Latch system 20 additionally includes a sear retainer 138.

Manual actuation lever 30 includes an actuation end 140 configured to extend 30 out of housing 22 (see FIG. 1) and an engagement end 142. A pivot member 144 (shown in dashed line form) is interposed between actuation end 140 and engagement end 142. Pivot member 144 extends outwardly from manual actuation lever 30 and engages with a pivot receiver 146 formed in second housing element 26. Pivot member 144 defines a pivot axis 147 about which manual actuation lever 30 is able to pivot. That is, manipulation of actuation end 140 causes manual actuation lever 30 to pivot about pivot axis 147. This function will be demonstrated in connection with FIG. 16.

Manual actuation lever 30 is coupled to an inner surface 148 of second housing element 26 via a spring 150. For example, a first end 152 of spring 150 is engaged with a post 153 extending outwardly from manual actuation lever 30 and a second end 154 of spring 150 is engaged with a post 156 extending outwardly from inner surface 148 of second housing element 26. Accordingly, after manual actuation lever 30 is manipulated, it will return to its original position through a spring force imparted by way of spring 150.

Manual actuation lever 30 further includes a bumper 158 extending outwardly from a side of lever 20. When latch system 20 is assembled, bumper 158 extends into cavity 105 (FIG. 7) of pocket 106 (FIG. 7). Under certain conditions, bumper 158 abuts ball 128 (FIG. 9) of actuation lock 108 (FIG. 9) to prevent movement of manual actuation lever 30. This function will be demonstrated in connection with FIGS. 17 and 18.

Sear retainer 138 includes post elements 160 shaped to reside in socket areas 162 of second housing element 26. A spring 164 is installed between inner surface 148 of second housing element 26 and sear retainer 138 so that sear retainer 138 is biased outwardly from inner surface 148. As such, when latch system 20 is assembled, sear retainer 138 is spring biased to move toward lateral surface 134 (FIG. 9) of catch member 28. An extension portion 166 of sear retainer 138 can thus abut catch member 28 and to slide over cam 136 (FIG. 9) as catch member 28 pivots. This feature will be demonstrated in connection with FIGS. 14 and 15.

Latch system 20 has a number of operational modes or positions. In one operational mode, inertial locking mechanism 95 (FIG. 7) of latch system 20 may be in a locked position so that catch member 28 is locked and unable to pivot, i.e., catch member 28 is in a latch position. In another operational mode, inertial locking mechanism 95 may be in an unlocked position, but catch member 28 has not yet pivoted. Therefore, although inertial locking mechanism 95 is in an unlocked position, catch member 28 is still in the latch position. In yet another operational mode, inertial locking mechanism 95 may be in an unlocked position and catch member 28 has now pivoted to a release position. The terms “locked position” and “unlocked position” used herein relate to the relative positions of swing lever 68 and sear element 70 of inertial locking mechanism 95. Whereas the terms “position” and “release position” used herein relate to the relative position of catch member 28.

FIGS. 11-15 are described herein to demonstrate the various operational modes of latch system 20. In FIGS. 11-15, housing 22 (FIG. 1), the components of actuation lock 108 (FIG. 9) and retainer element 124 (FIG. 9) have been removed for clarity.

Referring to FIGS. 11 and 12, FIG. 11 shows a partial side view of inertial locking mechanism 95 of latch system 20 in a locked position 168, and FIG. 12 shows a partial side view of inertial locking mechanism 95 of latch system 20 in locked position 168 with catch member 28 being engaged with latch receptacle 42 of apparatus 32 (FIG. 2). When inertial locking mechanism 95 is in locked position 168, latch area 71 of sear element 70 is in direct contact with engagement area 122 of catch member 28. In FIG. 11, sear retainer 138 is not shown in order to visualize the contact of sear element 70 with catch member 28.

When spring lever 68 pivots in, for example, a counterclockwise direction 172, about pivot axis 77 at pivot shaft 76, sear element 70 moves commensurately, in the opposite direction, e.g., a clockwise direction 174, about pivot axis 93 at pivot shaft 92 due to the geared engagement of gear teeth 78 on spring lever 68 with gear teeth 96 (see FIG. 7) on sear element 70. Thus, latch area 71 of sear element 70 is engaged with engagement area 122 so that catch member 28 is placed in a latch position 176 in which it is unable to pivot.

The locked position 168 of inertial locking mechanism 95 and the resulting latch position 176 of catch member 28 will occur when closure element 38 (FIG. 2) is closed on container 34 (FIG. 2). This operational mode is the default mode of latch system 20 and occurs automatically due to a spring force imposed on spring lever 68 by spring 82 (FIG. 7). This spring force causes spring lever 68 to pivot into locked position 168 so that sear element 70 is urged into substantially continuous engagement with catch member 28 in the absence of an acceleration event (discussed below). Therefore, spring lever 68 is biased toward the resulting latch position 176 of catch member 28 by spring 82 so that hook 112 of catch member 28 engages with latch receptacle 42. In such a configuration, bears and other animals cannot readily access the contents of container 34.

FIG. 13 shows a partial side view of inertial locking mechanism 95 of latch system 20 in an unlocked position 180, with catch member 28 still being engaged with latch receptacle 42. Unlocked position 180 of inertial locking mechanism 95 can occur when apparatus 32 (FIG. 2) is either lifted sharply by, for example, the automated, mechanical gripping arm of a truck or when apparatus 32 is briefly shaken by the gripping arm of the truck. The lifting action by the truck and/or the shaking action by the truck are referred to herein an acceleration event. An acceleration event is represented by an arrow 182 in FIG. 13.

In response to acceleration event 182, swing lever 68 pivots in clockwise direction 174 as a result of the presence of weight 80 located distally from the pivot axis at pivot shaft 76. That is, weight 80 on swing lever 68 tends to stay in its rest position relative to latch system 20 within apparatus 32 (FIG. 2) which moves generally independently from weight 80. Enough energy is extracted with this difference in motion to move inertial locking mechanism 95 into unlocked position 180. Accordingly, due to the geared engagement of swing lever 68 and sear element 70, sear element 70 pivots in the opposite direction, i.e., in counterclockwise direction 172 such that latch area 71 of sear element 70 is disengaged from engagement area 122 (visible in FIG. 11) of catch member 28.

At the bottom of the swing lever's 68 stroke, i.e., at its maximum amount of movement in clockwise direction 174, sear retainer 138 snaps into a position between catch 15 member 28 and sear element 70 so that sear element 70 and swing lever 68 are temporarily prevented from returning to locked position 168. It should be recalled that spring loaded plunger 118 (FIG. 8) extends outwardly from catch member 28. Once sear retainer 138 snaps into position between catch member 28 and sear element 70, catch member 28 can be pivoted against the resistance of plunger 118. However, catch member 28 will remain in latch position 176 until apparatus 32 (FIG. 2) and consequently latch system 20 is upended.

Referring to FIGS. 14 and 15, FIG. 14 shows a partial side view of inertial locking mechanism 95 of latch system 20 in unlocked position 180 with catch member 28 now being disengaged from latch receptacle 42, and FIG. 15 shows a partial front view demonstrating the functional interaction between components when catch member 28 is in a release position 184. It should be readily recalled from the discussion of FIG. 13 that although inertial locking mechanism 95 is in unlocked position 180, catch member 28 remains in latch position 176 until apparatus 32 is upended.

However, as now represented by FIGS. 14 and 15, apparatus 32 has been upended by, for example, the mechanical gripping arm of a truck. When apparatus 32 is upended, the weight of lid 38 (FIG. 2) is heavy enough to cause catch member 28 to rotate about pivot axis 111 at catch pivot 110 to release position 184 so that lid 38 falls open. Of course, since latch receptacle 42 is attached to lid 38, latch receptacle 42 moves out of contact with catch member 28 as lid 38 falls open. The contents of container 34 can now be emptied into the truck while lid 38 is open.

As catch member 28 swings, i.e., pivots about pivot axis 111, from latch position 176 (FIG. 12) to release position 184, extension portion 166 of sear retainer 138 comes into contact with and slides over cam 136. Cam 136 pushes sear retainer 138 outwardly, as represented by an arrow 186, from lateral surface 134 of catch member 28 and thus moves sear retainer 138 out of the way. With sear retainer 138 displaced outwardly, the spring force imposed on spring lever 68 by spring 82 (FIG. 7) causes spring lever 68 to pivot in counterclockwise direction 172 (FIG. 12) so that through their geared engagement, sear element 70 pivots in clockwise direction 174 (FIG. 12). Accordingly, inertial locking mechanism 95 returns to locked position 168 even while catch member 28 is still in release position 184.

When apparatus 32 is returned to its upright position, closure element 38 closes and latch receptacle 42 strikes catch member 28. The force from latch receptacle 42 causes catch member 28 to engage with latch receptacle 42 and rotate about pivot axis 111 back to latch position 176 (FIG. 12). Since spring lever 68 and sear element 70 have already automatically returned to locked position 168 and sear retainer 134 has been pushed out of the way by cam 136, latch area 71 of sear element 70 can again re-engage with engagement area 122 of catch member 28. Thus, catch member 28 returns to latch position 176 and is additionally unable to pivot, as demonstrated in FIG. 12.

It should be recalled that first housing element 24 includes detents 98 and 100 (FIG. 7) and catch member 28 includes spring-loaded plunger 118 (FIG. 8). Interconnection of plunger 118 with detent 98 temporarily keeps catch member 28 in release position 184 while apparatus 32 is upended. Detent 100 mitigates the potential for a premature movement of catch member 28 from latch position 176 (FIG. 12) to release position 184. That is, interconnection of plunger 118 with detent 100 temporarily keeps catch member 28 in latch position 176 when apparatus 32 is subjected to minor vibrations and movements prior to apparatus 32 being upended.

FIG. 16 shows a partial side view of latch system 20 being actuated utilizing manual actuation lever 30. Although latch system 20 is implemented to retain lid 38 (FIG. 2) secured to container 34 (FIG. 2), there are situations in which a user may wish to place an item, e.g., refuse 50 (FIG. 2), into container 34. Accordingly, manual actuation lever 30 enables a user to manually place inertial locking mechanism 95 in unlocked position 180 (FIG. 13) so that catch member 28 can swing to release position 184 (FIG. 14) as lid 38 is lifted by the user.

In order to initiate a manual release, actuation end 140 of manual actuation lever 30 is manipulated by a user, as indicated by an arrow 188. The manipulation of manual actuation lever 30 causes lever 30 to pivot about pivot axis 147 at pivot member 144 so as to move engagement end 142 of manual activation lever 30 into contact with swing lever 68. Swing lever 68 is thus urged to pivot in clockwise direction 174 so that sear element 70 pivots in counterclockwise direction 172 again causing sear element 70 to move out of engagement with catch member 28, thereby releasing catch member 28 and enabling catch member 28 to move to release position 184 (FIG. 14) when the user lifts lid 38.

Apparatus 32 (FIG. 2) having latch system 20 is discussed in connection with larger animals such as bears attempting to gain access to the contents of apparatus 32. However, such contents may be as great of a temptation to smaller animals, such as raccoons, squirrels, and the like. Raccoons can be especially problematic due to their intelligence, their ability to derive and remember solutions, and their extremely dexterous front paws. Although these smaller animals may not be able to reach manual actuation lever 30 when apparatus 32 is in an upright position, apparatus 32 could get tipped over by a larger animal, the wind, a vehicle, and so forth. When apparatus 32 is in a tipped over position, it is possible that a smaller persistent animal, such as a raccoon, may attempt to manipulate manual actuation lever 30 in order to gain access into apparatus 32. Accordingly, in some embodiments, latch system 20 includes actuation lock 108 so that even if an animal attempts to manipulate manual actuation lever 30, it will not be able to gain access into apparatus 32.

Referring to FIGS. 17 and 18, FIG. 17 shows a partial perspective view of actuation lock 108 incorporated into latch system 20, and FIG. 18 shows a partial perspective view of actuation lock 108 in a position that prevents actuation of manual actuation lever 30 when apparatus 32 (FIG. 2) is tipped, i.e., moved away from an upright position. It should be recalled that actuation lock 108 includes pocket 106 and pocket cover 130 (FIG. 9) fastened thereto. Ball 128 is configured to roll in cavity 105 of pocket 106. For clarity, pocket cover 130 is not shown in FIGS. 17 and 18 so that movement of ball 128 can be more readily visualized.

Bumper 158 of manual actuation lever 30 extends into cavity 105 of pocket 106. When apparatus 32 is in an upright position, ball 128 rolls to the bottommost position within cavity 105 due to the effect of gravity. Thus, bumper 158 is able to move over ball 128 in pocket 106 when actuation end 140 of manual actuation lever 30 is manipulated by a user, as discussed above in connection with FIG. 16. This upright configuration of apparatus 32 and the corresponding position of ball 128 is represented by FIG. 17.

When apparatus 32 is moved away from the upright position, for example, when apparatus 32 is tipped over, ball 128 rolls to the lowermost intermediate position within cavity 105 of pocket 106. In such a position, when actuation end 140 of manual actuation lever 30 is manipulated by, for example, a raccoon, bumper 158 abuts or strikes ball 128. Therefore, manual actuation lever 30 is prevented from movement so that any possible manipulation of lever 30 cannot urge inertial locking mechanism 95 into unlocked position 180 (FIG. 13). This tipped configuration of apparatus 32 and the corresponding position of ball 128 is represented by FIG. 18.

Thus, actuation lock 108 largely prevents unwanted intruders from gaining access to the contents of apparatus 32. Alternative designs may not call for the preventing smaller animals from getting into an apparatus that includes latch system 20. Therefore, alternative embodiments may not include actuation lock 108.

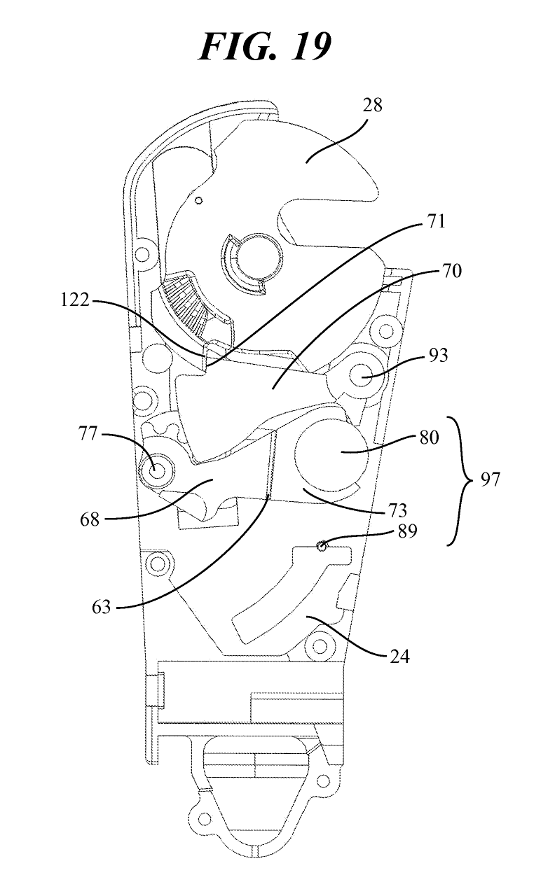

Referring to FIGS. 19-23, an embodiment of latch system 20 may further comprise a securing mechanism 97. Embodiments of securing mechanism 97 may comprise a holder assembly 73 and a blocking member 89 that may be configured to functionally engage one another in operational states of latch system 20 to be described herein in more detail.

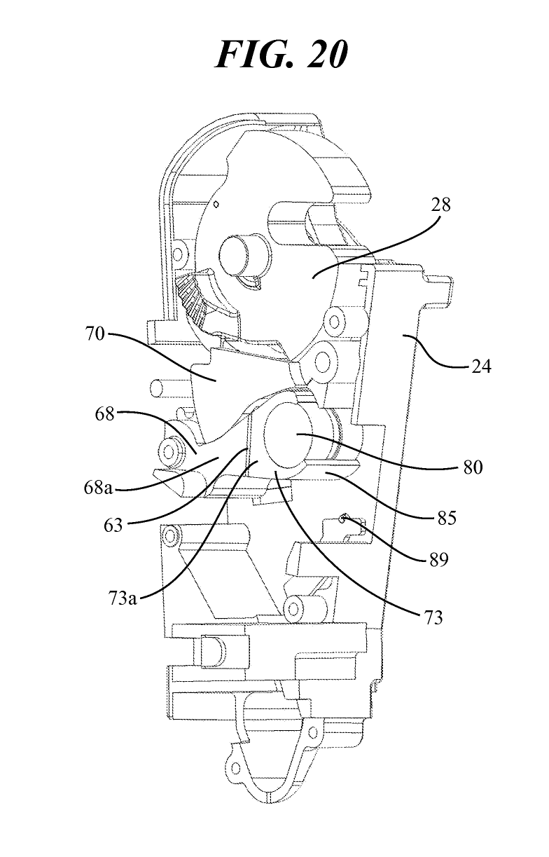

As depicted in FIGS. 19 and 20, embodiments of latch system 20 may further comprise holder assembly 73 being functionally coupled to swing lever 68 at joint 63 and being configured to functionally cooperate therewith. For example, holder assembly 73 may be configured to permit or conversely prohibit, as the case may be, swing lever 68 from transitioning between locked position 168 (FIG. 12) and unlocked position 180 (FIG. 13). Holder assembly 73 may be configured to pivot, or otherwise rotate, at joint 63 with respect to swing lever 68 in response to forces acting on container 34. The pivoting movement of holder assembly 73 in response to exterior forces acting on, or having acted on, container 34 may position holder assembly 73 in such a manner as to allow a surface 85 of holder assembly 73 to functionally engage blocking member 89. Once surface 85 is functionally engaged by blocking member 89, holder assembly 73, and thus swing lever 68 functionally coupled thereto, are prevented from transitioning from locked position 168 to unlocked position 180. Holder assembly 73 may also be configured to hold therein weight 80.

Embodiments of the latch system 20 may further comprise the blocking member 89 being positioned in or coupled to first housing element 24. Although not depicted, blocking member 89 may also be positioned in or coupled to second housing element 26. Further, blocking members 89 may be positioned in each of first housing element 24 and second housing element 26, such that two blocking members 89 may oppose one another on opposite interior surfaces of first housing element 24 and second housing element 26 of latch system 20. Blocking member 89 may be formed as an integral component of first housing element 24 or second housing element 26. Alternatively, blocking member 89 may be removable from first housing element 24 or second housing element 26. Blocking member 89 may also be adjustable with respect to first housing element 24 or second housing element 26. Specifically, blocking member 89 may be a screw or bolt that may be threaded further into the interior of latch system 20 or, in like manner, may be threaded out of the interior of latch system 20.

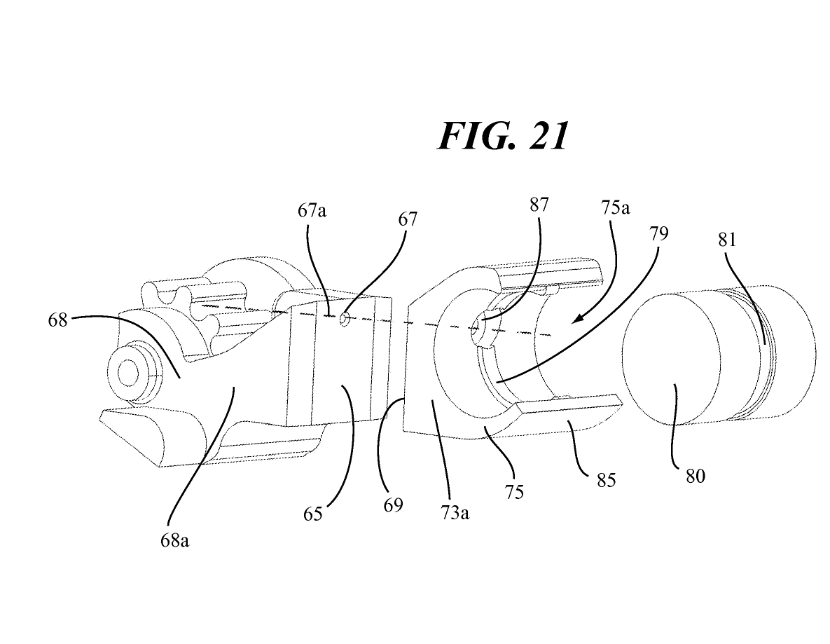

Referring to FIG. 21, an exploded view of swing lever 68 and holder assembly 73 is depicted. Swing lever 68 may further comprise a face 65 that contains a reception hole 67 thereon. Reception hole 67 may define an axis 67a about which holder assembly 73 may pivot when coupled thereto. Holder assembly 73 may further comprise a body 75 having an opposing face 69 thereon, face 69 being configured to correspond to and cooperate with face 65. Body 75 may also be configured to define a cavity 75a. Cavity 75a may have positioned therein a ridge 79, ridge 79 being configured to run radially along the interior circumference surface of cavity 75a. Cavity 75a may further define a retaining hole 87 therein, retaining hole 87 being configured to axially align with reception hole 67, such that a coupling component 83 may be inserted through retaining hole 87 and into reception hole 67 to functionally couple body 75 to swing lever 68. In this way, face 65 and face 69 may be brought into functional proximity with one another and may cooperate to permit holder assembly 73 to pivot, or otherwise rotate, about axis 67a with respect to swing lever 68 in response to forces acting on, or having acted on, container 34. Coupling component 83 may be fastened tight enough to prohibit body 75 from disengaging from swing lever 68, but yet loose enough to allow body 75 to freely pivot about axis 67a.

Embodiments of holder assembly 73 may further comprise weight 80. Weight 80 may be configured of a size and shape to be inserted within cavity 75a. Weight 80 may further comprise a groove 81 that may be configured of a size and shape to correspond to and/or functionally communicate with ridge 79 when weight 80 is positioned within cavity 75a. In other words, groove 81 may be configured on an exterior circumferential surface of weight 80, groove 81 being oriented radially about the circumference. The functional engagement between ridge 79 and groove 81 acts to prevent weight 80 from axially sliding out of, or otherwise dislodging from, cavity 75a due to forces acting on, or having acted on, container 34. In other words, when weight 80 is placed within cavity 75a of body 75, ridge 79 is configured to engage groove 81 to prevent weight 80 from being axially removed from body 75 without undue force.

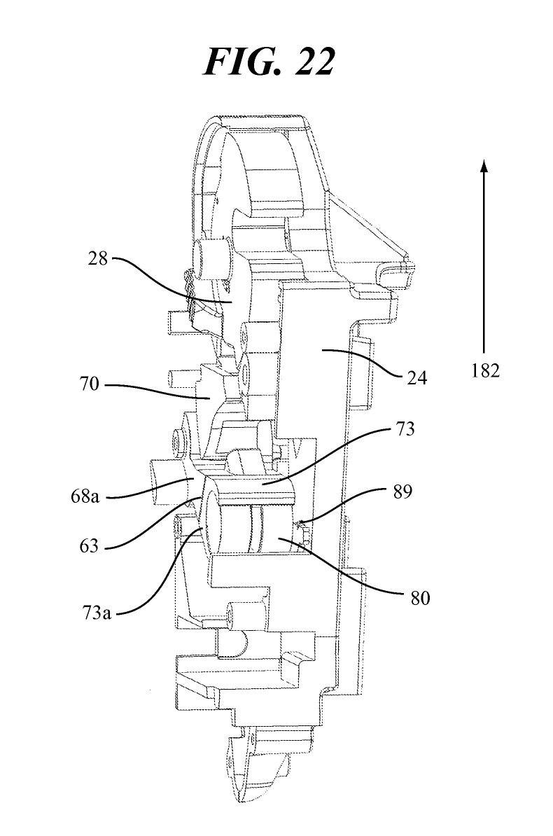

Referring again to FIG. 20, when apparatus 32 is in a normal and upright position, as shown in FIG. 2, holder assembly 73 of securing mechanism 97 is oriented in an upright and substantially vertical position. In other words, when apparatus 32 is in its upright position, a side surface 73a of holder assembly 73 is substantially coplanar with a side surface 68a of swing lever 68. In this way, under the condition that the automated, mechanical gripping arm of a truck engages apparatus 32 to create an acceleration event 182, acceleration event 182 causes weight 80 to transition from locked position 168 to unlocked position 180 without holder assembly 73 engaging blocking member 89. That is, the forces created by acceleration event 182 simply cause weight 80 to move from its rest position in locked position 168 to its unlocked position 180, which causes swing lever 68 to pivot about pivot axis 77, which pivoting causes sear element 70 to pivot about pivot axis 93, which pivoting releases latch area 71 from functional engagement with engagement area 122, which frees catch member 28 to rotate to release position 184, as described herein. As depicted in FIG. 22, acceleration event 182 does not cause holder assembly 73 to twist, pivot, or otherwise rotate, about pivot axis 67a. Thus, without pivoting about pivot axis 67a, holder assembly 73 remains in its upright and vertical position, which provides that contact surface 85 will not come into contact with blocking member 89. Instead, in its upright position, holder assembly 73 may move in conjunction with swing lever 68 and transition down and in between opposing blocking members 89 on either side of the interior of latch assembly 20 without contacting either of opposing blocking members 89. As a result, holder assembly 73 is free to pass by blocking member 89 as holder assembly 73, and thus swing lever 68, transition between locked position 168 and unlocked position 180.

Accordingly, with the configuration of securing mechanism 97 as described above, acceleration event 182 resulting from forces exerted on apparatus 32 by the automated, mechanical gripping arm of the truck during the process of emptying the contents of container 34 into the truck does not deter locking mechanism 95 from operating to allow lid 38 to open during this process as detailed herein above.

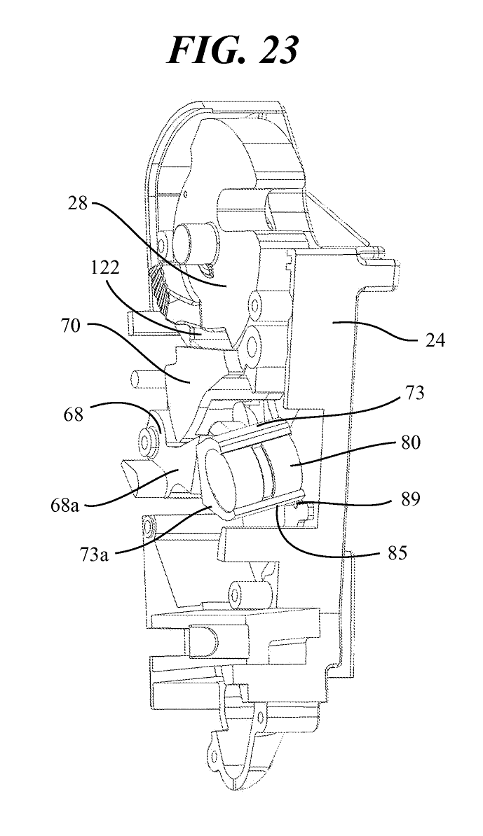

However, under the condition that apparatus 32 is tipped over on any of its sides by such things as wind, animals, or other circumstances, and remains on its side, securing mechanism 97 may prevent lid 38 from opening. By being on its side, apparatus 32 is oriented in a second orientation different than the upright position, or first orientation. The second orientation may be oblique to the first orientation or may be substantially orthogonal to the first orientation. As depicted in FIG. 23, holder assembly 73 is configured to twist, pivot, or otherwise rotate about pivot axis 67a in response to apparatus 32 being on its side and the resulting effects of gravity, such that surface 73a and surface 68a are not coplanar. In other words, when apparatus 32 is knocked on its side, holder assembly 73 is configured to twist, pivot, or otherwise rotate in either a clockwise or counterclockwise direction (counter-clockwise direction is depicted in FIG. 23), depending on which side apparatus 32 is knocked over onto, about pivot axis 67a with respect to swing lever 68. By so doing, a distal edge of contact surface 85 is brought into closer proximity with the interior surface of either first housing element 24 or second housing element 26, which brings contact surface 85 into range of blocking mechanism 89 that is positioned on the interior surface of either first housing element 24 or second housing element 26. Additionally, blocking mechanism 89 may be positioned on both first housing element 24 and second housing element 26, such that at least two blocking mechanisms 89 are configured within latch system 20 and oppose one another. Thus, whichever way holder assembly 73 rotates about pivot axis 67a in response to apparatus 32 being knocked over, contact surface 85 will contact at least one of opposing blocking mechanisms 89, or both. It follows that in this configuration, contact surface 85 will be in range of blocking mechanism 89, if holder assembly 73 and thus swing lever 68 attempt to pivot about pivot axis 77 from locked position 168 to unlocked position 180 due to forces acting on apparatus 32. With contact surface 85 in range of blocking mechanisms 89, contact surface 85 of holder assembly 73 may abut or otherwise engage blocking mechanism 89 to prevent swing lever 68 from transitioning all the way to unlocked position 180. Swing lever 68 is thus maintained, or otherwise secured, in locked position 168 by actuation of securing mechanism 97, which function retains sear element 70 in locked position 168, which retains latch area 71 in functional engagement with engagement area 122, which retains catch member 28 in latch position 176, which prevents lid 38 from opening, as described in detail herein above.

It follows that to open lid 38 after apparatus 32 has been tipped on its side, it is necessary to reposition apparatus 32 in its upright position, which allows holder assembly 73 to return to its upright and vertical position with respect to swing lever 68, where surface 73a is substantially coplanar with surface 68a. Spring 82 may assist swing lever 68 and holder assembly 73 in rising up off of blocking member 89 to allow holder assembly 73 to pivot back to its upright and vertical position.

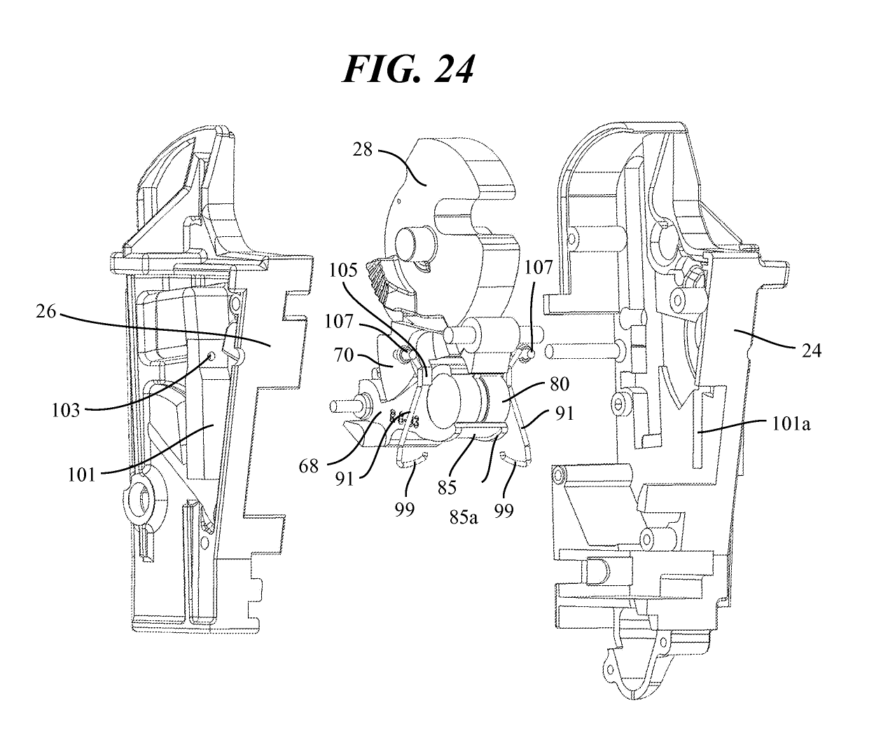

Referring now to FIGS. 24-27, embodiments of latch system 20 may further comprise alternative embodiments of securing mechanism 97. FIG. 24 provides an exploded exemplary view of an embodiment of securing mechanism 97, which may comprise an engagement member 91 being pivotally coupled to a pivot rod 107. The pivot rod 107 may be functionally coupled to either of first housing element 24 or second housing element 26. In addition, each of first housing element 24 and second housing element 26 may be configured with a respective pivot rod 107, such that the latch system 20 comprises a plurality of pivot rods 107, or at least one pivot rod 107 on either side of swing lever 68. Pivot rod 107 may be configured to functionally engage a respective engagement member 91. Thus, under the condition the latch system 20 comprises a plurality of pivot rods 107 the latch system 20 may further comprise a corresponding plurality of engagement members 91. The combination of pivot rod 107 and engagement member 91 may be configured to be housed within the interior of latch system 20. In particular, each of engagement members 91 may be configured to be housed within a housing 101 on each of first housing element 24 and second housing element 26. Engagement members 91 may be configured to oppose one another. Pivot rod 107 may be configured to be coupled to housing 101 at opening 103.

Embodiments of securing mechanism 97 may further comprise engagement member 91 being configured to pivot about pivot rod 107 in clockwise or counterclockwise directions orthogonal to an axis of pivot rod 107, such pivoting occurring in response to forces acting on apparatus 32 and/or the effects of gravity. Engagement member 91 may be configured to have a first end, which may be pivotally coupled to pivot rod 107, and a second end 99. Second end 99 may be configured in the shape of a hook or other similar shape to engage contact surface 85 under certain conditions. Corresponding second ends 99 of respective engagement members 91 may be configured to oppose one another such that a distance, or space, is established between opposing second ends 99.

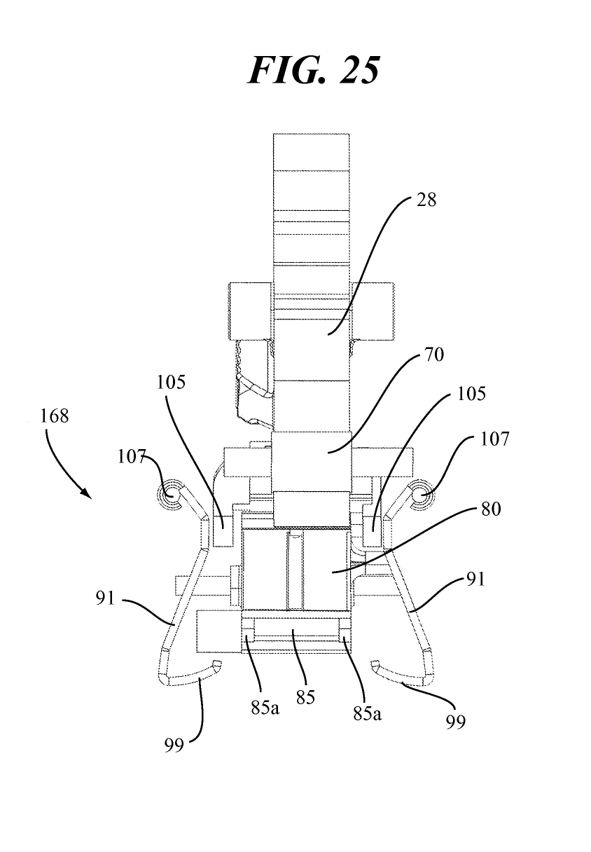

As depicted in FIG. 25, embodiments of securing mechanism 97 may comprise engagement member 91 being configured to hang from pivot rod 107 in a rest position within housing 101, under the condition that apparatus 32 is in an upright and vertical position, as depicted in FIG. 2. In this rest position, second end 99 of each of respective engagement members 91 may reside outside the reach of contact surface 85. Or, in other words, in this rest position, engagement members 91 may reside outside a path to be taken by contact surface 85 while transitioning between locked position 168 and unlocked position 180. That is, in the rest position of FIG. 25, neither of engagement members 91 will engage contact surface 85 in the event an acceleration event 182 should act on weight 80 to cause swing lever 68 to transition from locked position 168 to unlocked position 180. Engagement member 91 is configured such that acceleration event 182 does not act on engagement member 91 to cause engagement member 91 to pivot about pivot rod 107. Instead, acceleration event 182 simply causes weight 80 to move from locked position 168 to unlocked position 180, which causes swing lever 68 to pivot about pivot axis 77, which pivoting causes sear element 70 to pivot about pivot axis 93, which pivoting releases latch area 71 from functional engagement with engagement area 122, which frees catch member 28 to rotate to release position 184, as described herein.

Accordingly, under the condition that the automated, mechanical gripping arm of a truck engages apparatus 32 to create an acceleration event 182, acceleration event 182 causes weight 80 to transition from locked position 168 to unlocked position 180 but does not cause engagement members 91 to pivot about pivot rod 107 to engage contact surface 85. Stated another way, with the configuration of securing mechanism 97 having engagement member 91 as described above, acceleration event 182 resulting from forces exerted on apparatus 32 by the automated, mechanical gripping arm of the truck during the process of emptying the contents of container 34 into the truck does not cause securing mechanism 97 with engagement members 91 to deter locking mechanism 95 from operating to allow lid 38 to open during this process as detailed herein above.

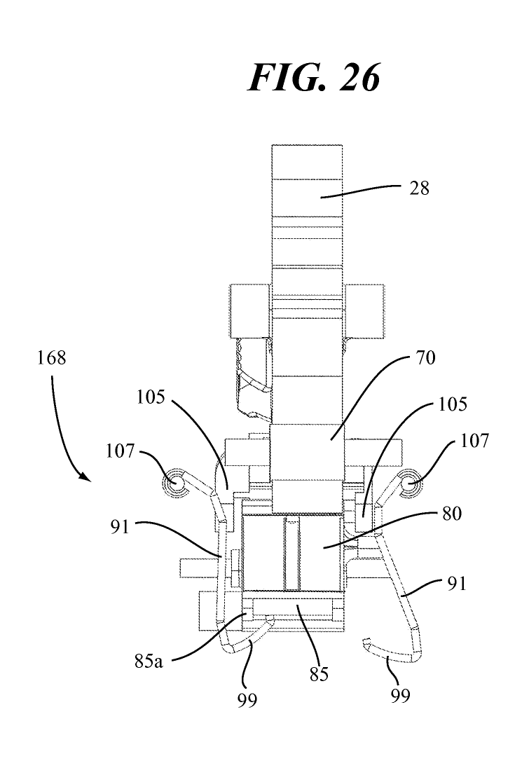

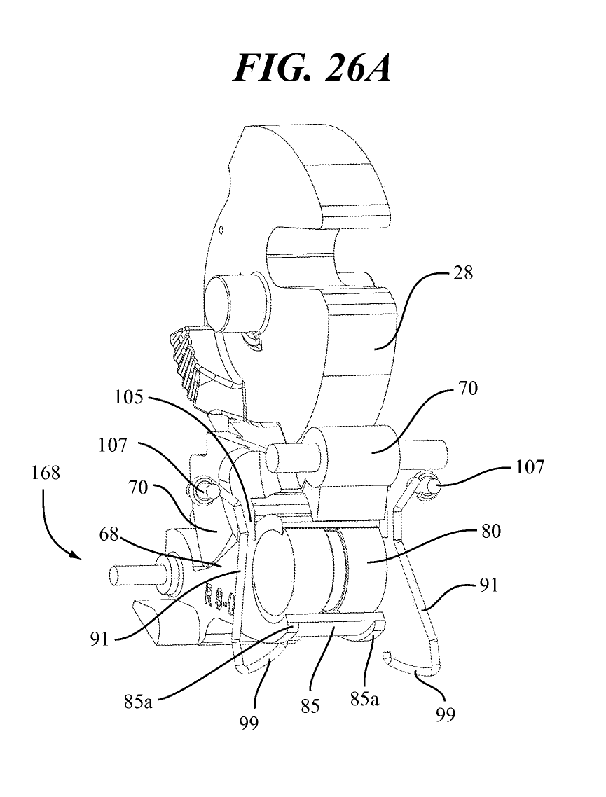

However, under the condition that apparatus 32 is tipped over on any of its sides by such things as wind, animals, or other circumstances, and remains on its side, securing mechanism 97 having engagement member 91 may prevent lid 38 from opening. By being on its side, apparatus 32 is oriented in a second orientation different than the upright position, or first orientation. The second orientation may be oblique to the first orientation or may be substantially orthogonal to the first orientation. With apparatus 32 on its side, forces acting upon apparatus 32, including gravity, may cause one of engagement members 91 to pivot about pivot rod 107 toward contact surface 85 to place second end 99 of the engagement member 91 in the path to be taken by contact surface 85, as depicted in FIG. 26. The other of engagement members 91 may pivot away from contact surface 85 due to gravity. However, should apparatus 32 tip over on another side, the roles of respective engagement members 91 may reverse. Nevertheless, regardless of which engagement member 91 is brought into proximity with contact surface 85 due to gravity, with second end 99 in the path of contact surface 85, should weight 80 and swing lever 68 attempt to move from locked position 168 to unlocked position 180, the second end 99 is configured to functionally engage contact surface 85 to prevent such movement. Additionally, contact surface 85 may further comprise raised edges 85a. Raised edges 85a may function to help prevent second end 99 from sliding off of or otherwise disengaging from contact surface 85 once engaged therewith, until apparatus 32 is returned to the upright position, as depicted in FIG. 26A. Thus, in the second orientation, by actuation of engagement members 91 to engage contact surface 85, swing lever 68 is maintained in locked position 168, which acts to retain sear element 70 in locked position 168, which retains latch area 71 in functional engagement with engagement area 122, which retains catch member 28 in latch position 176, which prevents lid 38 from opening, as described in detail herein above.

It follows that to thereafter open lid 38 after apparatus 32 has been tipped over on its side, apparatus 32 may be repositioned in its upright position, which allows engagement member 91 to return to its rest position. Specifically, spring 82 may assist swing lever 68 in rising up off of second end 99 to disengage contact surface 85 from second end 99 to allow engagement member 91 to pivot back to its rest position.

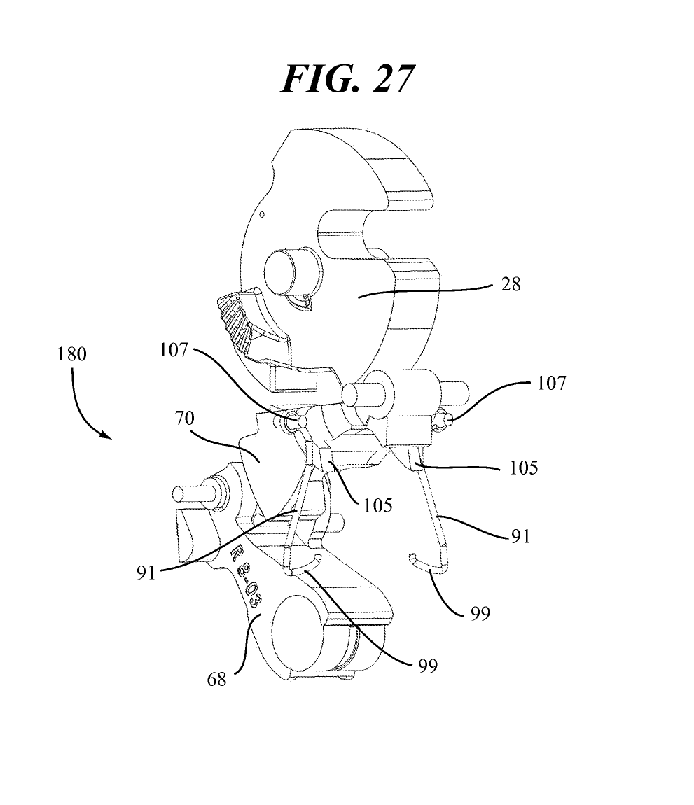

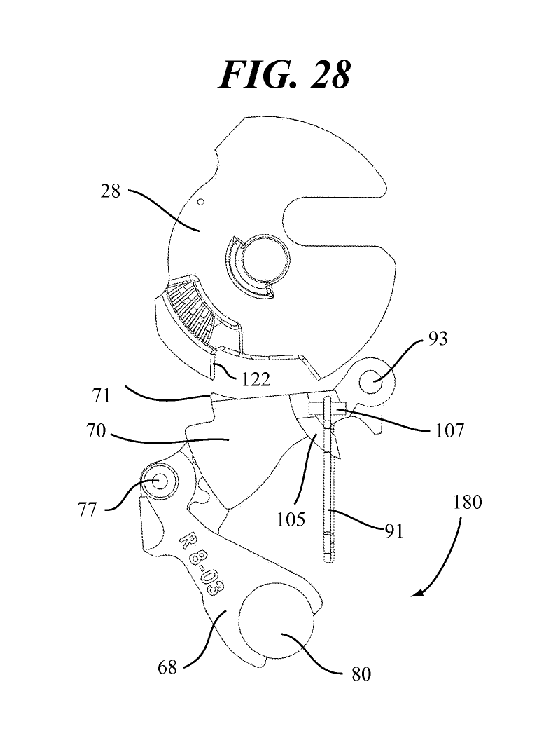

Referring now to FIGS. 27 and 28, embodiments of securing mechanism 97 having engagement members 91 may further comprise a restrictive member 105. Restrictive member 105 may be configured on sear element 70. As locking mechanism 95 moves from locked position 168 to unlocked position 180, restrictive member 105 may be configured on sear element 70 to slide between engagement member 91 and swing lever 68, or to slide between engagement member 91 and the path that swing lever 68 takes between locked position 168 and unlocked position 180, to prevent engagement members 91 from moving toward one another or into the path taken by swing lever 68. In this way, engagement members 91 are prevented from moving into the path taken by swing lever 68 while swing lever 68 is in unlocked position 180. That is, while locking mechanism 95 is in unlocked position 180, due to acceleration event 182, and lid 38 is thereby permitted to open and the contents of container 34 to be emptied, as explained herein above, restrictive member 105 prevents engagement member 91 from blocking locking mechanism 95 from returning to locked position 168 to relock lid 38 after apparatus 32 has been returned to its upright position by the automated mechanical arm.

Further, as depicted in FIG. 26, in locked position 168, restrictive member 105 is positioned with respect to engagement member 91 to permit engagement member 91 to move toward contact surface 85 without interfering therewith, under the condition that engagement member 91 is urged to move toward contact surface 85 due to apparatus 32 being placed on or knocked over on its side in the second orientation. In other words, restrictive member 105 is configured to block, or otherwise prevent engagement member 91 from moving toward contact surface 85 under the condition that locking mechanism 95 is in unlocked position 180 (see FIGS. 27 and 28), whereas restrictive member 105 does not prohibit the movement of engagement member 91 toward contact surface 85 under the condition that locking mechanism 95 is in locked position 168 (see FIGS. 25 to 26A).

In summary, embodiments entail a latch system for an enclosure, such as a container with a lid, and an apparatus that includes a container and a lid having the latch system incorporated therein. The latch system includes an inertial lock mechanism that includes a swing lever in geared engagement with a sear element. The sear element is typically engaged with a catch member that engages with a latch receptacle fastened to the closure element. When the latch system is subjected to an acceleration event, such as being sharply lifted or briefly shaken, a weight on the end of the swing lever causes the swing lever to pivot in one direction. Therefore, the sear element rotates in the opposing direction due to its geared engagement with the swing lever. This pivoting action moves sear element out of engagement with the catch member, thereby enabling the catch member to swing to a release position so that the lid having the latch receptacle can open. Thus, the latch system automatically unlatches when the container is sharply lifted or briefly shaken so that contents of the container can be accessed. The latch system then automatically re-engages when the container is returned to its upright position. The latch system can further include an actuation lock that prevents manual actuation of the latch system by an unwanted intruder when the apparatus having the latch system is tilted, tipped, or otherwise moved away from an upright position. The latch system can further include a securing mechanism that prevents undesired release or disengagement of the inertial lock mechanism when the apparatus having the latch system is tilted, tipped, or otherwise moved away from an upright position, such as on its side.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. For example, the lock system may be implemented to allow controlled access to a multitude of container designs, cupboards, gates, and the like. Additionally, other designs for the actuation lock may be adapted to react to tipping movement of the container and subsequently prevent release of the locking mechanism so that an intruder cannot gain entry into the apparatus. The claims provide the scope of the coverage of the present disclosure and should not be limited to the specific examples provided herein.

What is claimed is:

1. A latch system comprising:
a locking mechanism configured to transition between a locked position and an unlocked position; and
a securing mechanism configured to allow the locking mechanism to transition from the locked position to the unlocked position under the condition the latch system is oriented in a first orientation and to prevent the locking mechanism from transitioning from the locked position to the unlocked position under the condition the latch system is oriented in a second orientation different than the first orientation.

2. The latch system of claim 1, the locking mechanism further comprising:
a sear element; and
a swing lever in functional engagement with the sear element, the swing lever being configured to move in response to an acceleration event, such movement resulting in the locking mechanism transitioning from the locked position to the unlocked position.

3. The latch system of claim 2, the latch system further comprising:
a catch member in functional communication with the sear element and configured to transition between a latched position and a release position,
wherein under the condition the locking mechanism is in the locked position the catch member is maintained by the sear element in the latched position, and
wherein under the condition the locking mechanism is in the unlocked position the catch member is free to transition between the latched position and the release position.

4. The latch system of claim 3, the latch system further comprising:
a closure element to a container, the closure element being in functional communication with the catch member and being configured to transition between a closed position and an open position relative to the container,
wherein under the condition the catch member is in the latched position the closure element is maintained in the closed position, and
wherein under the condition the catch member is in the release position the closure element is free to transition between the closed position and the open position.

5. The latch system of claim 3, the latch system further comprising:
a housing in which at least portions of the catch member, the sear element, and the swing lever are located; and
a spring having a first end coupled to the swing lever and having a second end coupled to the housing, wherein the swing lever is biased toward a locked position by the spring to urge the sear element in substantially continuous engagement with the catch member in the absence of the acceleration event.

6. The latch system of claim 5, wherein the catch member comprises an engagement area and the sear element comprises a latch area configured for contact with the engagement area to retain the catch member in the latched position, the latch area moving out of contact with the engagement area in response to the acceleration event.

7. The latch system of claim 1, wherein the latch system has a length and the first orientation is defined as the length of the latch system being substantially upright and the second orientation is oblique to the first orientation.

8. The latch system of claim 1, wherein the latch system has a length and the first orientation is defined as the length of the latch system being substantially upright and the second orientation is substantially orthogonal to the first orientation.

9. The latch system of claim 1, the securing mechanism further comprising:
a holder assembly functionally coupled to the locking mechanism; and
a blocking member,
wherein under the condition the latch system is oriented in the first orientation the holder assembly is configured to permit the locking mechanism to transition from the locked position to the unlocked position without engaging the blocking member.

10. The latch system of claim 9, wherein the holder assembly is functionally coupled to a swing lever of the locking mechanism, the swing lever being configured to pivot between the locked position and the unlocked position about a first pivot axis and the holder assembly being configured to rotate with respect to the swing lever about a rotational axis substantially orthogonal to the first pivot axis.

11. The latch system of claim 9, wherein under the condition the latch system is oriented in the second orientation the holder assembly is configured to functionally engage the blocking member to prevent the locking mechanism from transitioning from the locked position to the unlocked position.

12. The latch system of claim 9, the securing mechanism further comprising:
a cavity defined by the holder assembly; and
a weight functionally coupled within the cavity,
wherein under the condition the latch system is in the first orientation the weight is configured to provide resistance to an acceleration event to cause the locking mechanism to transition between the locked position and the unlocked position, and
wherein under the condition the latch system is in the second orientation the weight is configured to cause the holder assembly to rotate about the rotational axis to engage the blocking member to prevent the locking mechanism from transitioning from the locked position to the unlocked position.

13. The latch system of claim 12, wherein the cavity further comprise a ridge thereon and the weight further comprises a groove therein, wherein the ridge is configured to functionally engage the groove under the condition the weight is coupled within the cavity.

14. The latch system of claim 1, the securing mechanism further comprising:
an engagement member; and
a contact surface on the locking mechanism,
wherein under the condition the latch system is oriented in the first orientation the engagement member is configured to permit the locking mechanism to transition from the locked position to the unlocked position without engaging the contact surface.

15. The latch system of claim 14, wherein the engagement member comprises a first end and a second end, the first end being configured to pivotally couple to a pivot rod and the second end being configured to engage the contact surface.

16. The latch system of claim 15, wherein under the condition the latch system is oriented in the second orientation the engagement member is configured to pivot about the pivot rod to bring the second end into functional engagement with the contact surface to prevent the locking mechanism from transitioning from the locked position to the unlocked position.

17. The latch system of claim 16, wherein the contact surface further comprises a raised edge that is configured to functionally engage second end and maintain functional engagement therewith under the condition the latch system is in the second orientation.

18. The latch system of claim 16, the securing mechanism further comprising:
a restrictive member functionally coupled to the locking mechanism,
wherein under the condition the locking mechanism is in the locked position the restrictive member is configured to permit the engagement member to pivot about the pivot rod to bring the second end into functional engagement with the contact surface, and
wherein under the condition the locking mechanism is in the unlocked position the restrictive member is configured to prevent the engagement member from pivoting about the pivot rod to bring the second end into functional engagement with the contact surface.

19. An apparatus comprising:
a container having an interior volume and an opening;
a closure element covering the opening, the closure element being movable relative to the container;
a latch receptacle secured to the closure element;
a latch system secured to the container and configured to functionally engage the latch receptacle to lock the closure element to the container, the latch system further comprising:
a catch member, the catch member including a catch pivot and a hook, the catch pivot enabling pivotable movement of the catch member between a latch position and a release position, and the hook engaging with the latch receptacle in the latch position and pivoting out of engagement with the latch receptacle in the release position;
a sear element engaged with the catch member under the condition the catch member is in the latch position;
a swing lever in geared engagement with the sear element, the swing lever pivoting in a first direction in response to an acceleration event to cause the sear element to pivot in a second direction opposing the first direction thereby disengaging from the catch member such that the catch member is able to pivot to the release position;
a housing in which at least portions of the catch member, the sear element, and the swing lever are positioned;
a spring having a first end coupled to the swing lever and having a second end coupled to the housing, wherein the swing lever is biased toward a locked position by the spring to urge the sear element in substantially continuous engagement with the catch member in the absence of the acceleration event; and
a securing mechanism configured to prevent the swing lever from pivoting under the condition the apparatus is in a first orientation to thereby maintain the catch member in the latch position and configured to allow the swing lever to pivot under the condition the apparatus is in a second orientation to thereby permit the catch member to transition from the latch position to the release position.

20. The apparatus of claim 19, further comprising a manual actuation lever having a first end extending out of the housing, a second end, and a pivot axis interposed between said first and second ends, wherein manipulation of the first end causes the manual actuation lever to pivot about the pivot axis to move the second end into abutment with the swing lever and urge the swing lever to pivot in the first direction thereby freeing the catch member to move to the release position.
